(19) United States
(12) Patent Application Publication
(10) Pub. No.: US 2014/0013973 A1
(43) Pub. Date: Jan. 16, 2014

(54) Print Tower for Offset Rotary Press

(71) Applicants: Didier Havard, La Chappelle sur Erdre (FR); Philippe Lechat, La Chappelle sur Erdre (FR)

(72) Inventors: Didier Havard, La Chappelle sur Erdre (FR); Philippe Lechat, La Chappelle sur Erdre (FR)

(73) Assignee: GOSS INTERNATIONAL CORPORATION, Durham, NH (US)

(21) Appl. No.: 13/630,825

(22) Filed: Sep. 28, 2012

(30) Foreign Application Priority Data
Sep. 29, 2011 (FR) 11 58726

(51) Int. Cl. B41F 13/193

(52) U.S. Cl. CPC B41F 13/193
USPC 101/217

(57) ABSTRACT

This printing tower for an offset rotary printing press comprises four vertically superposed double-sided printing units (10) for printing a continuous web, each printing unit (10) comprising two printing stations each comprising an associated coating form cylinder (12) and transfer cylinder (14), the transfer cylinders (14) of both printing stations (10) being provided for bearing against each other, each printing unit being laid out according to an [symbol] n [symbol] configuration or a [symbol] U [symbol] configuration.

According to one aspect of the invention, a printing unit (8A; 8D) is laid out according to one configuration and the three other printing units (8B, 8C, 8D; 8A; 8B, 8C) are laid out according to the other configuration.

The present invention relates to a printing tower for an offset rotary printing press of the type comprising four double-sided printing units vertically superposed for printing a continuous web, each printing unit comprising two printing stations each comprising a combined coating form cylinder and transfer cylinder, the transfer cylinders of both printing stations being provided so as to be bearing against each other, each printing unit laid out according to an [symbol] n [symbol] configuration in which the axis of the coating form cylinder of each printing station of the printing unit is shifted vertically downwards relatively to the axis of the associated transfer cylinder, or to a [symbol] U [symbol] configuration in which the axis of the coating form cylinder of each printing station of the printing unit is shifted vertically upwards relatively to the axis of the associated transfer cylinder.

US2008/0121125 discloses a printing tower for an offset rotary printing press comprising four double-sided printing units vertically superposed for printing a web. Each printing unit comprises two printing stations each for printing one respective face of the web. Each printing station comprises a plate holding cylinder, a blanket holding cylinder, an inking unit and a wetting unit. The printing units of the printing tower are selectively laid out in a so-called arch or [symbol] n [symbol] shape type configuration, in a so-called [symbol] U [symbol] shaped configuration open upwards or in a linear configuration.

Such layouts do not give the possibility of obtaining a compact tower in height, the printing units of which are easy to access for operators led to carrying out maintenance operations on the printing units.

One of the objects of the invention is to propose a printing tower which may be vertically compact and easy to access.

For this purpose, the invention proposes a printing tower of the aforementioned type, characterized in that a printing unit is laid out according to one configuration and the three other printing units are laid out according to the other configuration.

According to other embodiments, the printing tower comprises one or more of the following features taken individually or according to all technically possible combinations:
the lower printing unit and the upper printing unit are laid out according to different configurations, and the intermediate printing units are laid out according to the same configuration;
the upper printing unit is laid out in the [symbol] U [symbol] configuration and the three other printing units are configured in the [symbol] n [symbol] configuration;
the lower printing unit is laid out in the [symbol] n [symbol] configuration and the three other printing units are configured in the [symbol] U [symbol] configuration;
each coating form cylinder is a plate holding cylinder;
each printing station comprises a unit for automatic plate changing for automatic changing of plates on the plate holding cylinder;
each transfer cylinder is a blanket holding cylinder.

The invention also relates to an offset rotary printing press comprising at least one printing tower as defined above.

The invention and its advantages will be better understood upon reading the description which follows, only given as an example and made with reference to the appended drawings, wherein:

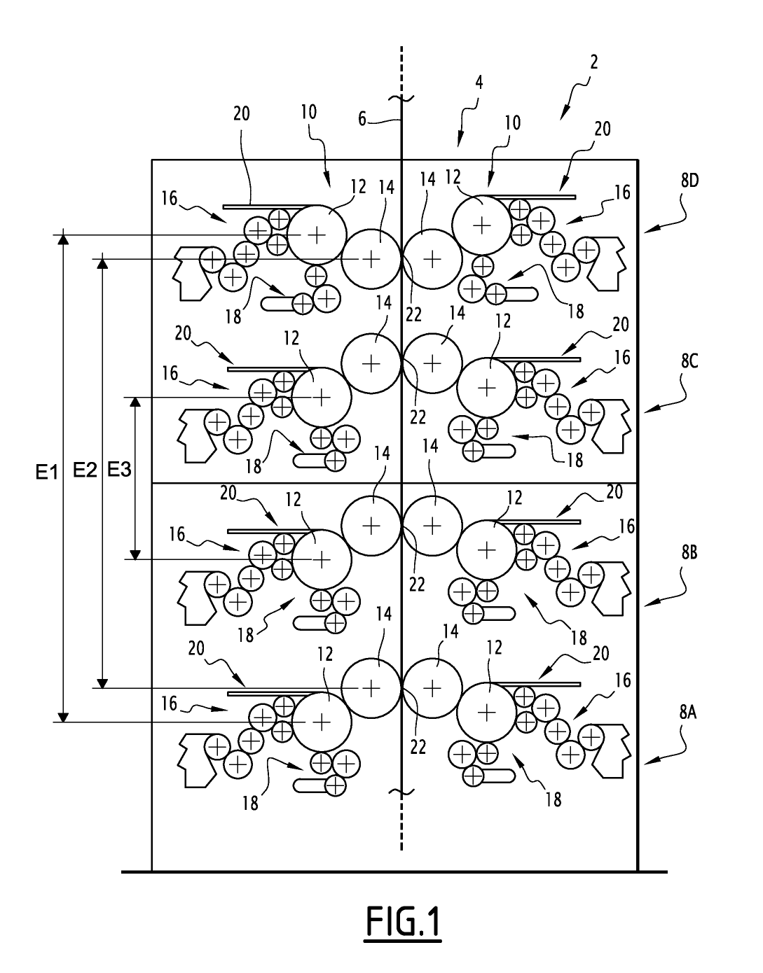

FIG. 1 schematically illustrates a printing tower of a rotary press according to the invention, according to a first embodiment; and

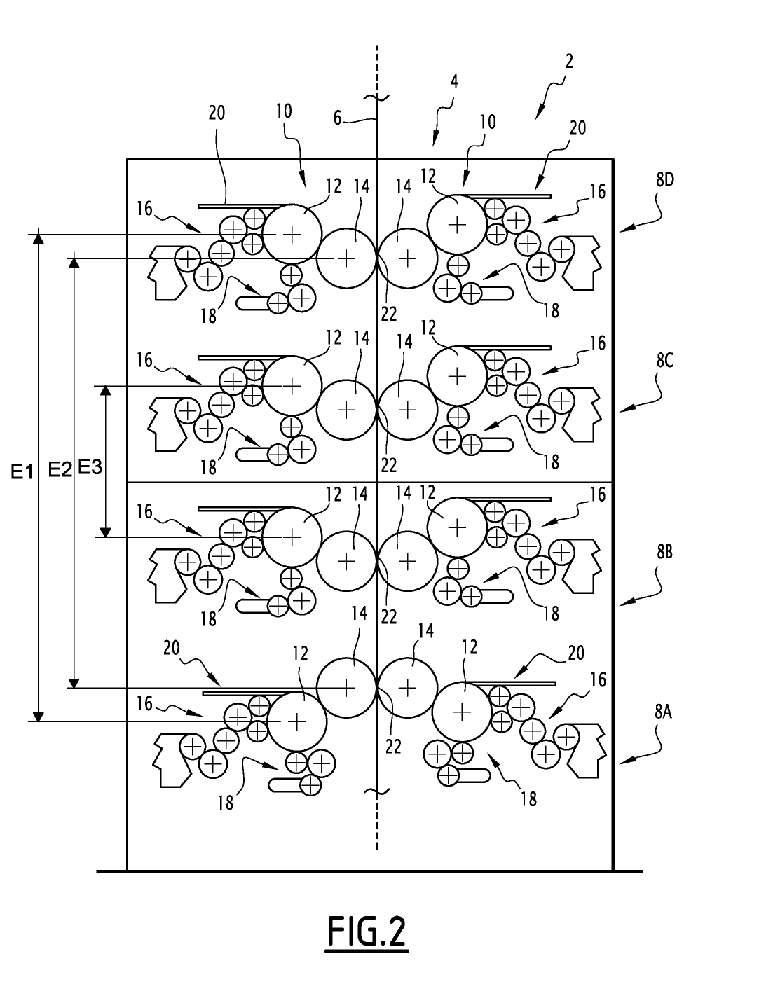

FIG. 2 schematically illustrates a printing tower of a rotary press according to the invention, according to a second embodiment.

As illustrated in FIG. 1, an offset rotary printing press 2 comprises a printing tower 4 adapted for offset printing of a continuous web 6, in particular a web of paper.

Only one printing tower 4 is illustrated. The rotary press 2 conventionally comprises several printing towers, each printing tower allowing the printing of a web. Downstream from the printing towers, the rotary press 2 conventionally comprises a set of combinations of printed webs giving the possibility of ensuring the joining, folding and longitudinal and/or transverse cutting of the webs, in order to provide folded sheets or signatures at the output. Upstream from the printing towers, the rotary press 2 generally comprises an assembly for unwinding the webs.

The printing tower 4 comprises four printing units 8A, 8B, 8C, 8D superposed vertically. In practice, each printing unit 8A, 8B, 8C, 8D is provided for printing one color on the web 6. The colors customarily used are: black, cyan, magenta and yellow.

The printing units 8A, 8B, 8C, 8D are double-sided printing units designed for double-sided printing of the web 6.

The printing units 8 are of similar configuration. Each printing unit 8A, 8B, 8C, 8D comprises two printing stations 10. Each printing station 10 is provided for printing a respective face of the web 6.

Each printing station 10 comprises a coating form cylinder 12, a transfer cylinder 14, an inking unit 16, a wetting unit 18 and as an option a plate changing unit 20.

The axes of the coating form cylinder 12 and of the transfer cylinder 14 are parallel.

The coating form cylinder 12 bears on its periphery the forms to be printed. The coating form cylinder 12 is here a plate holding cylinder provided for removably attaching flexible plates (not shown) bearing the forms to be printed. The plates are changed according to the productions to be carried out.

The transfer cylinder 14 is positioned so as to be in contact with the coating form cylinder 12 and to transfer the ink from the coating form cylinder 12 onto the web 6. The transfer cylinder 14 is here a blanket holding cylinder designed for receiving a blanket (not shown) on its periphery.

The inking unit 16 is designed for feeding the peripheral surface of the coating form cylinder 12 with ink. The inking unit 16 for example comprises an ink fountain or a train of inking rolls positioned between the ink fountain and the coating form cylinder 12 so as to pick up ink in the fountain and to deposit it on the periphery of the coating form cylinder 12. Other types of inking units may be contemplated.

The wetting unit 18 is designed for depositing a wetting liquid on the periphery of the coating form cylinder 12.

The plate changing unit 20 is designed so as to automatically change the plate(s) borne by the coating form cylinder 12. The plate changing unit 20 is optional. The changing of plates may be carried out manually.

The transfer cylinders 14 of both printing stations 10 of each printing unit 8A, 8B, 8C, 8D are positioned so that they will bear against each other. They define between them a nip slot 22 for the web 6. The transfer cylinders 14 nip the web 6 between them. Each transfer cylinder 14 defines for the other one a printing cylinder.

Such printing units are generally designated as being [symbol] blanket-over-blanket [symbol] printing units.

The printing units 8A, 8B, 8C 8D define a web path along which runs the web during the operation of the printing tower. Each printing unit 8A, 8B, 8C 8D comprises a printing station on one side of the web path in order to print one face of the web and a printing station on the opposite side for printing the other face of the web.

The printing units 8A, 8B, 8C, 8D comprise a lower or the lowest printing unit 8A, located below the other printing units 8B, 8C, 8D, an upper or uppermost printing unit 8D, located above the other printing units 8A, 8B, 8C, and two intermediate printing units 8B, 8C located vertically between the lower printing unit 8A and the upper printing unit 8D.

Each printing unit 8A, 8B, 8C, 8D is selectively laid out in a first so-called [symbol] n [symbol] configuration, in which the axis of the coating form cylinder 12 of each printing station 10 of the printing unit is vertically shifted downwards relatively to the axis of the transfer cylinder 14 of said printing station 10 or in a second so-called [symbol] U [symbol] configuration, in which the axis of the coating form cylinder 12 of each printing station 10 of the printing unit is vertically shifted upwards relatively to the axis of the transfer cylinder 14 of said printing station 10.

The [symbol] n [symbol] configuration is open downwards. The [symbol] n [symbol] configuration is also called an inverted [symbol] U [symbol] configuration or arch configuration. The [symbol] U [symbol] configuration is open upwards.

According to an aspect of the invention, one of the four printing units 8A, 8B, 8C, 8D is in one of the two configurations selected from the [symbol] n [symbol] configuration and the [symbol] U [symbol] configuration, and the three other printing units are in the other configuration.

Preferably, the lower printing unit 8A and the upper printing unit 8D are laid out according to different configurations and both intermediate printing units 8B, 8C are laid out according to the same configuration.

In the example illustrated in FIG. 1, the upper printing unit 8D is laid out according to a [symbol] U [symbol] configuration, and the three other printing units 8A, 8B, 8C located under the upper printing unit 8D are laid out according to a [symbol] n [symbol] configuration.

The result of such a layout is that on each side of the path along which runs the web 6 through the printing tower 4, a first center distance E1 between the coating form cylinders 12 of the lower printing unit 8A and of the upper printing unit 8D is larger than a second center distance E2 between the associated transfer cylinders 14. Thus, the printing tower 4 is vertically compact, while having a first significant center distance E1 conditioning the ease for accessing the transfer cylinders 14 between the plate cylinders 12.

The wetting cylinders 18 are positioned under the coating form cylinders 12 and prevent access to the transfer cylinders 14 from the bottom. Access to the transfer cylinders 14 of the upper printing unit 8D is easily accomplished from the top. The [symbol] n [symbol] configuration of the other printing units 8A, 8B, 8C facilitates access to the transfer cylinders 14 of these printing units 8A, 8B, 8C from the top, in the intervals between the coating form cylinders 12.

In the illustrated example, the printing units 8A, 8B, 8C 8D are distributed vertically so that on each side of the travel path, the pitch E3 between the axes of the coating form cylinders 12 is regular for also easily accessing the transfer cylinders 14 of the lower printing unit 8A and of the intermediate printing units 8B, 8C.

FIG. 2, in which numerical references have been retained for the elements similar to those of FIG. 1, illustrate a printing tower 4 according to a second embodiment.

The printing tower 4 differs from that of FIG. 1 in that the lower printing unit 8A is laid out according to an [symbol] n [symbol] configuration and the three other printing units 8B, 8C, 8D located above the lower printing unit 8A are laid out according to a [symbol] U [symbol] configuration.

With this layout it is possible to keep a vertically compact printing tower 4 with facilitated access to the transfer cylinders 14 between the coating form cylinders 12 of the printing units 8A, 8B, 8C, 8D on each side of the path along which travels the web 6. Access to the transfer cylinders 14 of the intermediate printing units 8B, 8C is nevertheless less easy than in the case of FIG. 1.

Generally, the printing tower comprises four superposed double-sided printing units each laid out according to an [symbol] n [symbol] configuration or a [symbol] U [symbol] configuration, the lower printing unit and the upper printing unit being laid out according to different configurations and both intermediate printing units being laid out according to the same configuration. Preferably, the lower printing unit is laid out according to an [symbol] n [symbol] configuration and the upper printing unit is laid out according to a [symbol] U [symbol] configuration.

By means of the invention, access to the printing units between the coating form cylinders is facilitated for the operators while giving the possibility of obtaining a printing tower with reduced height for easy access to the transfer cylinders, without providing a chassis bearing the printing units, made in two mobile portions, each mobile portion bearing a respective printing station of each printing unit, so as to be able to move the mobile portions apart in order to access the printing unit cylinders. Therefore it is not necessary to provide space around the printing tower for the displacement of the mobile portions, so that the printing tower has a small footprint. It is not necessary to provide a mechanism for displacing mobile portions, which complexifies the printing tower and reduces its reliability and its manufacturing and maintenance costs.

What is claimed is:

1. A printing tower for an offset rotary printing press, comprising four vertically superposed double-sided printing units (10) for printing a continuous web, each printing unit (10) comprising two printing stations each comprising a coating form cylinder (12) and a transfer cylinder (14), associated with each other, the transfer cylinders (14) of both printing stations (10) being provided for bearing against each other, each printing unit being laid out according to an [symbol] n [symbol] configuration, in which the axis of the coating form cylinder (12) of each printing station of the printing unit is vertically shifted downwards relatively to the axis of the associated transfer cylinder (14) or a [symbol] U [symbol] configuration in which the axis of the coating form cylinder (12) of each printing station of the printing unit is vertically shifted upwards relatively to the axis of the associated transfer cylinder (14), characterized in that a printing unit (8A; 8D) is laid out according to one configuration and the three other printing units (8B, 8C, 8D; 8A; 8B, 8C) are laid out according to the other configuration.

2. The printing tower according to claim 1, wherein the lower printing unit (8A) and the upper printing unit (8D) are laid out according to different configurations, and the intermediate printing units (8B, 8C) are laid out according to the same configuration.

3. The printing tower according to claim 1, wherein the upper printing unit (8D) is laid out in the [symbol] U [symbol] configuration and the three other printing units are configured in the [symbol] n [symbol] configuration.

4. The printing tower according to claim 1, wherein the lower printing unit (8A) is laid out in the [symbol] n [symbol] configuration and the three other printing units are configured in the [symbol] U [symbol] configuration.

5. The printing tower according to claim 1, wherein each coating form cylinder is a plate holding cylinder.

6. The printing tower according to claim 1, wherein each printing station comprises an automatic plate changing unit for automatically changing the plates on the plate holding cylinder.

7. The printing tower according to claim 1, wherein each transfer cylinder is a blanket-holding cylinder.

8. A rotary printing press comprising at least one printing tower according to claim 1.
